(19) United States
(12) Patent Application Publication
(10) Pub. No.: US 2025/0346796 A1
(43) Pub. Date: Nov. 13, 2025

(54) COMPOSITIONS

(71) Applicant: Strata Control Services, Inc., The Woodlands, TX (US)

(72) Inventors: Steven Edward DAIGLE, The Woodlands, TX (US); Cenk BURGAZLI, The Woodlands, TX (US)

(21) Appl. No.: 19/054,349

(22) Filed: Feb. 14, 2025

Related U.S. Application Data
(60) Provisional application No. 63/554,348, filed on Feb. 16, 2024.

(51) Int. Cl. C09K 8/28

(52) U.S. Cl. CPC C09K 8/28; C09K 2208/34

(57) ABSTRACT

An additive composition for an aqueous drilling fluid including at least one lubricity additive and at least one emulsifier compound.

### FIELD

The invention relates to an additive composition for an aqueous drilling fluid, to a drilling fluid composition comprising the additive composition, to the use of the additive composition to provide lubricity in an aqueous drilling fluid and to a method of providing lubricity in an aqueous drilling fluid. The invention also relates to a method and use of the additive composition to emulsify a lubricity additive in an aqueous drilling fluid. In particular, the invention relates to an additive composition for an aqueous drilling fluid wherein the additive composition has an HLB value of from 10 to 18.

### BACKGROUND

Hydrocarbons (for example crude oil or natural gas) are recovered from boreholes (wells) drilled deep into the earth. Conventionally a borehole is drilled using a rotary drill bit on the end of a rotatable, hollow, drill pipe using an appropriate drilling fluid.

Drilling fluids are typically formulated into drilling fluid compositions, which are a complex mixture of liquids and solids formulated to provide the specific physical and chemical characteristics required to safely drill a well. Particular functions of a drilling fluid composition include cooling and lubricating a drill bit, lifting rock cuttings to the surface, preventing the destabilization of the rock at the wellbore walls and applying a hydrostatic pressure at the bit to overcome the pressure of fluids inside the rock so that these fluids do not enter the wellbore and progress to the surface uncontrollably. While both oil-based and water-based drilling fluids are available, it is preferable to use water-based drilling fluids for economic and environmental reasons.

Drilling fluid compositions typically contain a lubricity additive to reduce frictional pressures in drilling operations, such as frictional pressures inside the drill pipe and associated annulus. Preferred lubricity additives that are commonly used with oil-based drilling fluids typically cannot be emulsified in water, especially in water containing a high amount of ions. This makes these lubricity additives incompatible with water-based drilling fluids, for example those made with brines. However, lubricity additives that are soluble and/or compatible with water-based drilling fluids are often less effective than those used with oil-based drilling fluids.

Thus, there remains a need for alternative and/or improved additive compositions for increasing the lubricity of aqueous drilling fluids. It is desirable for such additive compositions to be useful in a lower treat rate than alternative additive compositions.

### SUMMARY

It is thus an objective of the invention to enable the use of a poorly water soluble lubricity additive in an aqueous drilling fluid. For example, it is an objective of the invention to provide an additive composition that may be used effectively with an aqueous drilling fluid and/or that improves the lubricity of aqueous drilling fluids, especially those having a high salt content, for example aqueous drilling fluids comprising calcium ions.

According to a first aspect of the invention, there is provided an additive composition for an aqueous drilling fluid, the additive composition comprising at least one lubricity additive and at least one emulsifier compound.

According to a second aspect of the invention, there is provided a drilling fluid composition comprising an aqueous drilling fluid and the additive composition according to the first aspect.

According to a third aspect of the invention, there is provided a method of preparing a drilling fluid composition, the method comprising admixing an aqueous drilling fluid, the additive composition according to the first aspect, and optionally one or more friction reducer compounds.

According to a fourth aspect of the invention, there is provided a use of an additive composition according to the first aspect to provide lubricity in an aqueous drilling fluid.

According to a fifth aspect of the invention, there is provided a method of providing lubricity in an aqueous drilling fluid, the method comprising admixing the additive composition according to the first aspect with the aqueous drilling fluid.

According to a sixth aspect of the invention, there is provided a method of emulsifying at least one lubricity additive in an aqueous drilling fluid, the method comprising providing the additive composition according to the first aspect comprising the lubricity additive, and admixing the additive composition with the aqueous drilling fluid.

According to a seventh aspect of the invention, there is provided a use of an additive composition according to the first aspect to emulsify the at least one lubricity additive in an aqueous drilling fluid.

According to an eighth aspect of the invention there is provided a use of an aqueous drilling composition according to the second aspect in a drilling operation.

According to a ninth aspect of the invention there is provided a method of drilling, wherein the method comprises drilling through a medium using a suitable drilling assembly in the presence of an aqueous drilling fluid according to the second aspect.

### DETAILED DESCRIPTION

Unless otherwise stated, the following terms used in the specification and claims have the meanings set out below.

The terms “alkyl” and “alkylene” include both straight and branched chain alkyl and alkylene groups respectively unless otherwise stated.

The term “aryl” as used herein refers to an organic moiety derived from an aromatic hydrocarbon by removal of one hydrogen, and includes any monocyclic, bicyclic or polycyclic carbon ring of up to 7 members in each ring, wherein at least one ring is aromatic.

The term “aralkyl” as used herein refers to alkyl moieties substituted with an aryl group, wherein the aryl group is an organic moiety derived from an aromatic hydrocarbon by removal of one hydrogen, and includes any monocyclic, bicyclic or polycyclic carbon ring of up to 7 members in each ring, wherein at least one ring is aromatic. An example of an aralkyl group is a benzyl group.

The term “hydrocarbyl” is used in its ordinary sense, which is well-known to those skilled in the art. Specifically, it refers to a group having a carbon atom directly attached to the remainder of the molecule and having predominantly hydrocarbon character.

References herein for example to a C12 group mean a group with 12 carbon atoms, and so on for a C32 group etc. As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.70 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

For the avoidance of doubt, wherein amounts of components in a composition are described in wt %, this means the weight percentage of the specified component in relation to the whole composition referred to. For example, “wherein the additive composition comprises the at least one lubricity additive in an amount of from 5 to 95 wt % means that 5 to 95 wt % of the additive composition is provided by the at least one lubricity additive.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

In this specification any reference to ppm is to parts per million by weight.

Preferred features of the first, second, third, fourth, fifth, sixth and seventh aspects of the invention will now be described. Any feature may apply to any other aspect as appropriate.

According to a first aspect of the invention, there is provided an additive composition for an aqueous drilling fluid, the additive composition comprising at least one lubricity additive and at least one emulsifier compound.

By “additive composition for an aqueous drilling fluid” we mean a composition suitable for being additised to an aqueous drilling fluid that imparts a desired effect to the aqueous drilling fluid.

The term “drilling fluid composition” may also be known in the art as a drilling mud and would be well understood by a person skilled in the art to mean a composition used in drilling operations to provide the specific physical and chemical characteristics required to safely drill a well.

The drilling fluid compositions disclosed herein comprise an aqueous drilling fluid, which may also be known as a water-based mud. Typical components of such fluids/muds will be known to a person skilled in the art.

By an aqueous drilling fluid we mean that the drilling fluid predominantly comprises water. For example, a suitable aqueous drilling fluid may comprise up to 100 vol % water. As the skilled person would appreciate, water may be provided by at least one of brine, freshwater, produced water, formation water, and seawater, preferably freshwater, produced water or a mixture thereof.

Preferably the additive composition according to the first aspect has a hydrophobic-lipophilic balance (HLB) value of from 10 to 18, for example from 12 to 18 or from 12 to 16.

The term “HLB value” would be well understood by a person skilled in the art to mean a measure of the degree of hydrophilicity or lipophilicity of the additive composition, i.e. of the combined components of the additive composition.

As the skilled person would appreciate, HLB values can either be calculated or experimentally determined. Experimental methods to determine HLB values include using comparative testing by forming a series of emulsions with an emulsifier and an oil of known HLB value.

The present inventors have identified that providing an additive composition with a HLB value of from 10 to 18 enables the or each lubricity additive to become and remain emulsified within an aqueous drilling fluid, so that the lubricity additive can provide effective lubrication in the aqueous drilling fluid (especially wherein the aqueous drilling fluid comprises calcium ions).

The additive composition according to the first aspect comprises at least one lubricity additive. Thus, the composition may comprise one lubricity additive or two or more lubricity additives. References herein to “a” lubricity additive or “the” lubricity additive, unless otherwise specified, also apply to aspects in which two or more such additives are present. As the skilled person will appreciate, each lubricating additive may comprise a mixture of compounds.

By “lubricity additive” we mean a compound or composition that acts to improve the lubricity of a drilling fluid to which it is added (i.e, wherein it is added in an additive amount). For example, the improvement in the lubricity of the drilling fluid may lower the drag and/or torque between moving surfaces in a drilling operation in which the drilling fluid is used.

The additive composition may comprise the at least one lubricity additive in any suitable amount, such as an amount of from 5 to 95 wt %, for example from 10 to 75 wt %.

Suitable lubricity additives are commercially available and known to persons skilled in the art. The lubricity additive may or may not be soluble in and/or emulsifiable with water. Preferably the lubricity additive is not soluble in and/or emulsifiable with water.

Suitably the or each lubricity additive is selected from an ester lubricity additive, an acid lubricity additive and an amide lubricity additive, or a salt thereof (i.e. a salt of any of the aforesaid). Mixtures of these lubricity additives may be used

The additive composition may comprise a mixture of two or more of an ester lubricity additive, an acid lubricity additive and an amide lubricity additive, or a salt thereof. For example, the additive composition may comprise a mixture of an ester lubricity additive and an acid lubricity additive, or a salt thereof, and so on.

The additive composition may comprise only one of an ester lubricity additive, an acid lubricity additive and an amide lubricity additive, or a salt thereof.

In one aspect, the additive composition may comprise an ester lubricity additive, or a salt thereof.

In one aspect, the additive composition may comprise an acid lubricity additive, or a salt thereof. In one aspect, the additive composition may comprise an amide lubricity additive, or a salt thereof.

Any suitable ester containing lubricity additive may be used as an ester lubricity additive. Suitable compounds will be known to the person skilled in the art.

Any compound which includes an ester functional group and improves the lubricity of a drilling fluid to which it is added may be regarded as an ester lubricity additive.

Suitably, the or each ester lubricity additive comprises the reaction product of reactants comprising an alcohol and a carboxylic acid or a reactive equivalent thereof.

By a reactive equivalent of a carboxylic acid we mean to include any functional group which may react in the same way as a carboxylic acid to form an ester moiety. Such compounds are sometimes referred to as acylating agents.

Suitable acylating agents include anhydrides and acid chlorides, as well as carboxylic acids. Preferred acylating agents are hydrocarbyl substituted.

The carboxylic acid or reactive equivalent thereof used to prepare the or each ester lubricity additive may comprise or be derived from a monocarboxylic acid or a polycarboxylic acid. References herein to a polycarboxylic acid include dicarboxylic acids.

Suitably, the or each ester lubricity additive comprises the reaction product of reactants comprising an alcohol and a carboxylic acid or a reactive equivalent thereof, wherein the carboxylic acid or reactive equivalent thereof is selected from a monocarboxylic acid and a polycarboxylic acid, or an anhydride thereof.

Preferably the carboxylic acid or reactive equivalent thereof includes a hydrocarbyl moiety, preferably having from 2 to 50, suitably from 4 to 40, for example from 6 to 36, carbon atoms. The hydrocarbyl moiety is suitably a straight chain or branched alkyl or alkenyl chain.

Preferably, the carboxylic acid or reactive equivalent thereof may be selected from a monocarboxylic acid, a dicarboxylic acid or an anhydride thereof.

Suitably, the carboxylic acid or reactive equivalent thereof may be a polycarboxylic acid, for example a dicarboxylic acid, or a reactive equivalent thereof, for example an anhydride thereof.

Preferably, the carboxylic acid or reactive equivalent thereof may be a hydrocarbyl substituted succinic acid or a hydrocarbyl substituted succinic anhydride.

Hydrocarbyl substituted succinic acids or anhydrides are typically prepared by the reaction of an alkene with maleic anhydride.

The product may be optionally hydrolysed to form the diacid which is then reacted with an alcohol to from an ester or the anhydride can be directly reacted with an alcohol. Suitable alcohols are described herein.

The alkene may suitably have from 2 to 75, such as from 2 to 50, preferably from 4 to 40, for example from 6 to 36, carbon atoms. For example, the alkene may be a polyolefin, for example a polyisobutene.

For example, the alkene may be an α-olefin. The term α-olefin is used to refer to an alkene compound having a terminal double bond. Such compounds are also commonly described as terminal alkenes.

Preferably, the alkene is an internal olefin. The term internal olefin is used to refer to any alkene compound in which the alkene group is not terminal. Internal olefins may be prepared by isomerisation of an α-olefin. A suitable internal olefin may be a β-olefin.

Suitably, the carboxylic acid or reactive equivalent thereof may be a hydrocarbyl substituted succinic acid or anhydride thereof in which the hydrocarbyl substituent has from 4 to 40, suitably from 6 to 36, preferably from 10 to 32, for example from 12 to 30, preferably from 12 to 24, for example from 12 to 20, carbon atoms. For example, the hydrocarbyl substituent may have from 14 to 18 or from 16 to 18 carbon atoms.

Suitably, the carboxylic acid or reactive equivalent thereof may be a hydrocarbyl substituted succinic acid or anhydride thereof having a substituent derived from an α-olefin having 6 to 36, preferably from 10 to 30, suitably from 12 to 24, for example from 14 to 18 or from 16 to 18, carbon atoms.

Suitably, the carboxylic acid or reactive equivalent thereof may be a hydrocarbyl substituted succinic acid or anhydride thereof having a substituent derived from an internal olefin having from 6 to 36, preferably from 10 to 32, suitably from 12 to 24, for example 14 to 18 or from 16 to 18, carbon atoms.

Suitably, the carboxylic acid or reactive equivalent thereof may be a polyisobutenyl substituted succinic acid or anhydride thereof. Preferably the polyisobutenyl substituent has a number average molecular weight of from 80 to 5000, preferably from 100 to 1000, more preferably from 400 to 1000.

Preferred polyisobutenyl substituted succinic acids or anhydrides include those having a polyisobutenyl substituent with a number average molecular weight of about 260 or about 550. A polyisobutenyl substituent number average molecular weight of about 260 is especially preferred.

Suitably, the carboxylic acid or reactive equivalent thereof may comprise a monocarboxylic acid, for example a fatty acid.

Suitable fatty acids include compounds of formula R^{x}COOH in which R^{x} is an alkyl or alkenyl group having from 5 to 35, preferably from 7 to 29 or from 11 to 23, carbon atoms.

Suitable fatty acids include caprylic acid, capric acid, lauric acid, myristic acid, palmitic acid, stearic acid, arachidic acid, behenic acid, lignoceric acid, cerotic acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, undecylenic acid and docosahexenoic acid. One preferred fatty acid is oleic acid.

Mixtures of fatty acids may also be used, for example, tall oil fatty acid. Tall oil fatty acid comprises a mixture of predominantly unsaturated fatty acids having mostly 18 carbon atoms. Typically tall oil fatty acids comprise mainly oleic acid and linoleic acids.

The skilled person will appreciate that fatty acids derived from natural sources typically comprise mixtures of compounds.

To form the ester lubricity additives used in the invention, the carboxylic acid or reactive equivalent thereof is reacted with an alcohol.

When the carboxylic acid or reactive equivalent thereof comprises more than one carboxylic acid group or reactive equivalent thereof, one or more than one of the carboxylic acid groups may react with the alcohol to form an ester. Thus the ester lubricity additive may comprise a monoester of a dicarboxylic acid, a diester of dicarboxylic acid, a monoester of a polycarboxylic acid, a diester of a polycarboxylic acid or a polyester of a polycarboxylic acid.

Any suitable alcohol may be used. In some embodiments the alcohol may be a short chain monohydric alcohol, such as an alcohol having from 1 to 6 carbon atoms, for example methanol, ethanol, propanol or butanol.

Preferably the or each ester lubricity additive comprises the reaction product of a carboxylic acid or reactive equivalent thereof and a polyhydric alcohol.

The term polyhydric alcohol is used to refer to any compound including two or more OH functional groups.

When the ester lubricity additive is prepared from a polyhydric alcohol one or more than one of the hydroxy groups may be esterified.

Preferred polyhydric alcohols suitable for use herein are compounds having from 2 to 10, preferably from 2 to 6, more preferably 2 or 3, hydroxy groups.

Preferably, the carboxylic acid or reactive equivalent thereof is reacted with a polyhydric alcohol of formula H—(OR)ₙ—OH, wherein R is an optionally substituted alkylene group and n is at least 1. Preferably n is from 1 to 10, more preferably from 1 to 4.

Suitably the polyhydric alcohol of formula H—(OR)ₙ—OH may have more than 2 hydroxy groups and the group R may be a hydroxy substituted alkylene group. Such a group may have 1, 2 or more hydroxy groups.

Suitably the polyhydric alcohol of formula H—(OR)ₙ—OH may be a sugar derived unit in which R includes one or more hydroxy residues.

R may be substituted to form a cyclic alkylene unit. One or more heteroatoms may be present in the cyclic alkylene unit. For example the unit may contain an ether linkage.

Suitably R may be one or more saccharide units or may be substituted with one or more saccharide units.

Suitably the polyhydric alcohol of formula H—(OR)ₙ—OH may be selected from glycerol, pentaerythritol and trimethylolpropane.

Suitably the polyhydric alcohol of formula H—(OR)ₙ—OH may be a sugar component for example, trehalose or sorbitol.

Suitably R may be an unsubstituted alkylene group.

Preferably R may be an optionally substituted alkylene group having from 1 to 50, such as from 1 to 40, preferably from 1 to 30, more preferably from 1 to 20, suitably from 1 to 10, for example from 2 to 6 or from 2 to 4, carbon atoms.

Preferably R may be an unsubstituted alkylene group having from 1 to 50, preferably from 1 to 20, more preferably from 1 to 10, suitably from 2 to 6, for example from 2 to 4, carbon atoms. R may be straight chained or branched.

Suitably R may be an ethylene, propylene, butylene, pentylene, or hexylene group. When R has more than 2 carbon atoms any isomer may be present. Preferably R is an ethylene or a propylene group, most preferably an ethylene group.

When n is 1, R may be a group of formula (CH₂)ₓ wherein x is from 2 to 12, preferably from 2 to 6.

Suitably when n is 1, R may be a straight chain or branched alkylene group and the polyhydric alcohol may be selected from ethylene glycol, propylene glycol, 1,3-propanediol, 1,2-butanediol, 1,3-butanediol, 1,4-butanediol, 1,6-hexanediol and neopentyl glycol.

Suitably when n is 1, R may be a straight chain or branched alkylene group having from 2 to 6, preferably from 2 to 5, carbon atoms.

Suitable compounds of this type include ethylene glycol, propylene glycol, 1,3-propanediol, 1,2-butanediol, 1,3-butanediol, 1,4-butanediol and neopentyl glycol.

R may comprise a mixture of isomers. For example when R is propylene, the polyhydric alcohol may include moieties —CH₂CH(CH₃)— and —CH(CH₃)CH₂— in any order within the chain.

R may comprise a mixture of different groups for example ethylene, propylene or butylene units.

R may be an ethylene, propylene or butylene group. R may be an n-propylene or n-butylene group or an isopropylene or isobutylene group. For example R may be—CH₂CH₂—, —CH₂CH(CH₃)—, —CH₂CH₂CH₂—, —CH₂C(CH₃)₂, —CH₂CH₂CH₂CH₂—, —CH(CH₃)CH(CH₃)— or —CH₂CH(CH₂CH₃)—.

Preferably R is selected from is-CH₂CH₂—, —CH₂CH₂CH₂—, —CH(CH₃)CH₂— or —CH₂CH(OH)CH₂. Suitably, the polyhydric alcohol may be selected from ethylene glycol, diethylene glycol, propylene glycol, dipropylene glycol, glycerol and diglycerol.

The or each ester lubricity additive may be prepared by the reaction of a carboxylic acid or reactive equivalent thereof and an alcohol.

In aspects in which the carboxylic acid or reactive equivalent thereof comprises two or more carboxylic acid functional groups and/or wherein the alcohol comprises a polyhydric alcohol, a mixture of products may be obtained.

In some aspects, the carboxylic acid or reactive equivalent thereof and the alcohol may be reacted in a molar ratio of from 5:1 to 1:30, suitably from 2:1 to 1:20, preferably from 1:1 to 1:10, based on the ratio of COOH groups (or reactive equivalent thereof) in the carboxylic acid compound to OH groups present in the alcohol compound.

Preferably an excess of alcohol groups are present relative to carboxylic acid groups or reactive equivalents thereof in the reaction used to prepare the ester lubricity additive. For the avoidance of doubt an anhydride functional group is a reactive equivalent of two COOH groups.

When the carboxylic acid or reactive equivalent thereof is a dicarboxylic acid, this may be initially reacted with a first alcohol and then subsequently further reacted with a second different alcohol. In this case the reaction product may comprise a diester compound including two different ester functional groups. For example the first alcohol may be a monohydric alcohol and the second alcohol may be a polyhydric alcohol. A diester compound may also be formed by reaction of a dicarboxylic acid and two molar equivalents of the same alcohol.

The or each ester lubricity additive preferably comprises the reaction product of a polyhydric alcohol and a carboxylic acid or reactive equivalent thereof selected from fatty acids, hydrocarbyl substituted succinic acids and hydrocarbyl substituted succinic anhydrides.

Ester lubricity additives suitable for use herein may comprise an ester of a monocarboxylic acid or a reactive equivalent thereof and a polyhydric alcohol.

Preferably the monocarboxylic acid is a fatty acid of formula R^{x}COOH wherein R^{x} is an alkyl or alkenyl group having from 5 to 35, preferably from 7 to 29, more preferably from 11 to 23, carbon atoms. The fatty acid may be saturated or unsaturated. Preferably the fatty acid is unsaturated and R^{x} is an alkenyl group. The alkenyl group may have one or more double bonds, for example 1, 2 or 3 double bonds.

Examples of suitable saturated carboxylic acids include capric acid, lauric acid, myristic acid, palmitic acid, and behenic acid.

Examples of suitable unsaturated carboxylic acids include oleic acid, elaidic acid, palmitoleic acid, petroselic acid, ricinoleic acid, eleostearic acid, linoleic acid, linolenic acid, eicosanoic acid, galoleic acid, erucic acid and hypogeic acid.

Unsaturated fatty acids are preferred. Preferably the monocarboxylic acid is an unsaturated carboxylic acid having from 12 to 24, preferably from 16 to 18, carbon atoms.

Mixtures of fatty acids can be used, including natural mixtures, for example tall oil fatty acid.

The alcohol which is reacted with the monocarboxylic acid may be a polyhydric alcohol.

Examples of suitable polyhydric alcohols include aliphatic, saturated or unsaturated, straight chain or branched alcohols having from 2 to 10, preferably from 2 to 6, more preferably from 2 to 4, hydroxy groups, and having from 2 to 90, preferably from 2 to 30, more preferably from 2 to 12, most preferably from 2 to 5, carbon atoms in the molecule. Suitably the polyhydric alcohol may have at least 3 hydroxy groups. Suitably the polyhydric alcohol may be a glycol or diol, or a trihydric alcohol, for example glycerol. Preferably the polyhydric alcohol is glycerol or diglycerol. Most preferably the polyhydric alcohol is glycerol.

Examples of esters of polyhydric alcohols that are suitable ester lubricity additives include those where all of the hydroxy groups are esterified, those where not all of the hydroxy groups are esterified, and mixtures thereof. Preferred compounds include for example glycerol monooleate, glycerol dioleate and partial esters of glycerol and tall oil fatty acid. For example, a preferred such ester is a reaction product of glycerol and a fatty acid, wherein the glycerol and fatty acid are reacted in a 1:1 to 1:3, preferably a 1:1 to 1:2, molar ratio.

The ester may have one or more free hydroxy groups. Preferably not all of the alcohol groups are esterified.

Further ester lubricity additives suitable for use herein may comprise the reaction product of one or more alcohols and a hydrocarbyl substituted succinic acid or anhydride thereof.

Preferably, the or each ester lubricity additive may comprise the reaction product of a polyhydric alcohol and a hydrocarbyl substituted succinic acid or anhydride thereof.

The or each ester lubricity additive may preferably comprise the reaction product of a succinic acid of formula (I) or a succinic anhydride of formula (II):

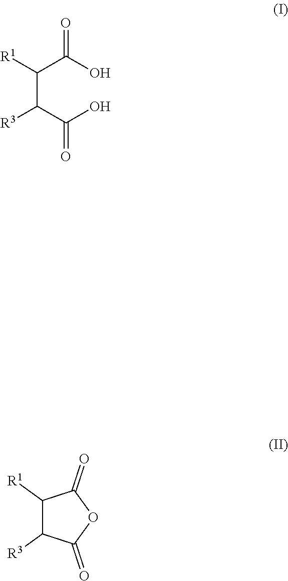

and an alcohol, wherein one of R¹ and R³ is an alkyl or alkenyl group, and the other of R¹ and R³ is hydrogen. Preferably one of R¹ and R³ is an alkenyl group, and the other of R¹ and R³ is hydrogen.

Preferably the or each ester lubricity additive may comprises the reaction product of a compound of formula (I) or (II) and a polyhydric alcohol.

The reaction product may comprise compounds of formula (III), (IV) or (V):

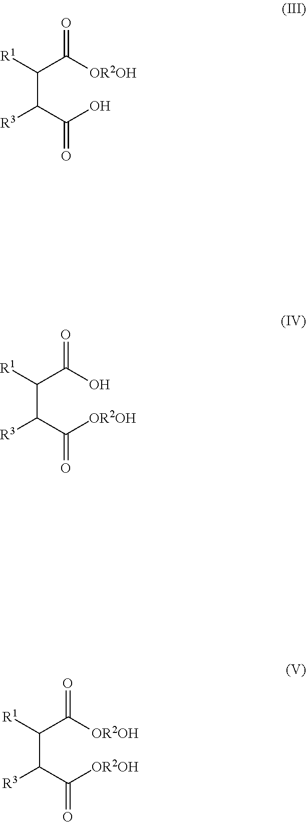

wherein R² is an optionally substituted alkylene group and R¹ and R³ are as defined herein.

The reaction product may also comprise oligomers of formula (VI):

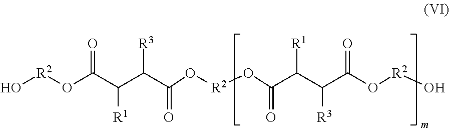

wherein m is 0 or an integer from 1 to 20, in each succinic acid moiety one of R¹ and R³ is an alkyl or alkenyl group, and the other of R¹ and R³ is hydrogen; and R² is an optionally substituted alkylene moiety.

R² is an optionally substituted alkylene moiety and is suitably derived from a polyhydroxy alcohol. R² may include one of more hydroxy substituents and/or one or more ether linkages within the alkylene chain.

In any individual succinic acid moiety, if R¹ is alkyl or alkenyl then R³ is hydrogen and vice versa. However the pattern of substitution along the oligomer chain need not be identical.

Preferably m is at least 1, more preferably at least 2. Suitably m may be up to 11, more preferably up to 10, more preferably up to 8, more preferably up to 6 and most preferably up to 5.

The or each ester lubricity additive may comprise the reaction product of a compound of formula (I) or (II) with a polyhydric alcohol and a monohydric alcohol. For example, the reaction product may comprise compounds of formula (VII) or (VIII):

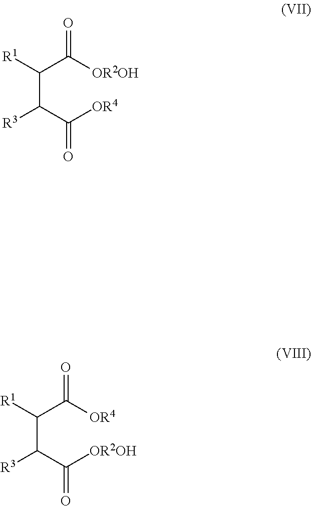

wherein R⁴ is the residue of the monohydric alcohol and R¹, R² and R³ are as previously defined.

Preferably, the or each ester lubricity additive may comprise the reaction product of a compound of formula (I) or (II) and a polyhydric alcohol and the reaction product comprises compounds of formula (III), (IV), (V) and/or (VI).

Preferably one of R¹ and R³ is a C12 to C32 group, for example a C14 to C18 group, especially a C16 group.

R¹ or R³ may comprise a mixture of chain lengths and there can be some branching such as methyl, ethyl and higher alkyl branching. R¹ and R³ can be derived from polymerised olefins, for example polymerised ethylene, polymerised propylene, polymerised butylene or polymerised mixtures of such olefins.

Suitably, one of R¹ and R³ is derived from an internal olefin.

Internal olefins contain predominantly a non-terminal double bond, such as a β or higher olefin. Preferably such materials are substantially completely β or higher olefins, for example containing less than 10% by weight a olefin, more preferably less than 5% by weight or less than 2% by weight. Typical internal olefins include Neodene 151810 available from Shell.

Internal olefins are sometimes known as isomerised olefins and can be prepared from α-olefins by isomerisation.

The number average molecular weight of the alkenyl group R¹ or R³ may preferably be at least 168, most preferably at least 180. The number average molecular weight of the alkenyl group R¹ or R³ is preferably up to 1200, more preferably up to 1120, most preferably up to 448.

Suitably, one of R¹ and R³ may be a C1 to C150 alkenyl group, such as an olefin or polyolefin. Suitably, one of R¹ and R³ is the residue of an α-olefin having from 6 to 36, preferably from 10 to 30, suitably from 12 to 24, for example from 12 to 18 or from 14 to 18, carbon atoms.

Suitably, one of R¹ and R³ is the residue of an internal olefin having from 6 to 36, preferably from 10 to 30, suitably from 12 to 24, for example from 12 to 18 or from 14 to 18, carbon atoms.

Suitably, one of R¹ and R³ is a C16 to C80 group and more preferably a polyisobutene (PIB) group. The number average molecular weight of the PIB is preferably from 200 to 2000, more preferably 260 to 1000, for example about 260, 320, 350, 550, 750 or 1000. Conventional PIBs and so-called “high-reactivity” PIBs (for example as described in EP565285) are suitable. High reactivity in this context is defined as a PIB wherein at least 50%, preferably 70% or more, of the terminal olefinic double bonds are of the vinylidene type, for example the GLISSOPAL compounds available from BASF.

R² is an optionally substituted alkylene group, preferably derived from a polyhydric alcohol.

The polyhydric alcohol from which R² is derived may, for example, be selected from ethylene glycol, diethylene glycol, propylene glycol, dipropylene glycol, glycerol and diglycerol.

Preferably, the polyhydric alcohol may be a dihydroxy alcohol, preferably having primary hydroxyl groups, at the respective ends of the carbon backbone.

Suitably the polyhydric alcohol is selected from ethylene glycol, glycerol or diethylene glycol. Preferably, the polyhydric alcohol is ethylene glycol.

When the succinic acid or anhydride thereof is also reacted with a monohydric alcohol R⁴OH, R⁴ in formulae (VII) and (VIII) is the residue of the monohydric alcohol.

R⁴ may be an optionally substituted alkyl, alkenyl or aryl group. Preferably R⁴ is an alkyl group, preferably an unsubstituted alkyl group.

R⁴ is preferably an alkyl group having from 1 to 6 carbon atoms, preferably methyl, ethyl, propyl or isopropyl. An especially preferred monohydric alcohol is isopropanol.

The succinic acid/anhydride ester lubricity additives comprise compounds that are always at least semi-esterified. Mixtures of the fully and semi-esterified compounds in a variety of ratios are also within the invention. The degree of esterification may be determined according to the acid number, i.e. the amount of NaOH required to neutralise 1 g of the compound. The acid number is less than 90 mg NaOH/g, preferably less than 50 mg NaOH/g, for example less than 20 mg NaOH/g, less than 10 mg NaOH/g or less than 5 mg NaOH/g.

Suitably in preparing the ester lubricity additives the compound of formula (I) or (II) and a polyhydric alcohol are reacted in a molar ratio of from 2:1 to 1:10, suitably from 1.5:1 to 1:5, preferably from 1:1 to 1:3 based on the ratio of COOH groups (or reactive equivalent thereof) in the compound of formula (I) or (II) to OH groups present in the polyhydric alcohol.

Further details of succinic acid derived ester lubricity additives and methods of preparing the same are described in EP1910504, GB2381789 and EP902804.

Preferably, the or each ester lubricity additive may be selected from one or more of:
(i) esters of a polyhydric alcohol having at least three hydroxy groups and one or more unsaturated fatty acids having from 12 to 24 carbon atoms wherein not all of the alcohol groups are esterified;
(ii) the reaction product of a polyhydric alcohol and a compound of formula (I) or (II) in which one of R¹ and R³ is derived from an internal olefin having from 12 to 32 carbon atoms and the other one of R¹ and R³ is hydrogen;
(iii) the reaction product of a compound of formula (I) or (II) in which one of R¹ and R³ is a hydrocarbyl group having from 10 to 32 carbon atoms, a polyhydric alcohol and a monohydric alcohol wherein the reaction product comprises compounds of formula (VII) and (VIII);
(iv) the reaction product of a polyhydric alcohol and a compound of formula (I) or (II) in which one of R¹ and R³ is derived from an α-olefin having from 10 to 30 carbon atoms and the other one of R¹ and R³ is hydrogen; and
(v) the reaction product of a polyhydric alcohol and a compound of formula (I) or (II) in which one of R¹ and R³ is a polyisobutylene group and the other one of R¹ and R³ is hydrogen.

Preferably the or each ester lubricity additive is selected from one or more of:
(i) monoesters and/or diesters of glycerol and one or more unsaturated fatty acids having from 12 to 24 carbon atoms;
(ii) the reaction product of a polyhydric alcohol selected from ethylene glycol, diethylene glycol, propylene glycol, dipropylene glycol, glycerol and diglycerol and compound of formula (I) or (II) in which one of R¹ and R³ is derived from an internal olefin having from 12 to 24 carbon atoms and the other one of R¹ and R³ is hydrogen;
(iii) the reaction product of a compound of formula (I) or (II) in which one of R¹ and R³ is a polyisobutene (PIB) group and the number average molecular weight of the PIB is from 100 to 1000; a monohydric alcohol selected from methanol, ethanol, propanol or isopropanol; and a polyhydric alcohol selected from ethylene glycol, diethylene glycol, propylene glycol, dipropylene glycol, glycerol and diglycerol wherein the reaction product comprises compounds of formula (VII) and (VIII);
(iv) the reaction product of a polyhydric alcohol selected from ethylene glycol, diethylene glycol, propylene glycol, dipropylene glycol, glycerol and diglycerol and a compound of formula (I) or (II) in which one of R¹ and R³ is derived from an α-olefin having from 12 to 24 carbon atoms and the other one of R¹ and R³ is hydrogen; and
(iv) the reaction product of a polyhydric alcohol selected from ethylene glycol, diethylene glycol, propylene glycol, dipropylene glycol, glycerol and diglycerol and a compound of formula (I) or (II) in which one of R¹ and R³ is a polyisobutene (PIB) group and the number average molecular weight of the PIB is from 100 to 1000 and the other one of R¹ and R³ is hydrogen.

Preferably the or each ester lubricity additive is selected from one or more of:
(i) monoesters and/or diesters of glycerol and one or more unsaturated fatty acids selected from oleic acid and tall oil fatty acid;
(ii) the reaction product of a polyhydric alcohol selected from ethylene glycol, diethylene glycol, propylene glycol, dipropylene glycol, glycerol and diglycerol and compound of formula (I) or (II) in which one of R¹ and R³ is derived from an internal olefin having 14 to 18 carbon atoms and the other one of R¹ and R³ is hydrogen, wherein the compound of formula (I) or (II) and the polyhydric alcohol are reacted in a molar ratio of from 2:1 to 1:20 based on the ratio of COOH groups (or reactive equivalent thereof) in the compound of formula (I) or (II) to OH groups present in the polyhydric alcohol;
(iii) the reaction product of a compound of formula (I) or (II) in which one of R¹ and R³ is a polyisobutene (PIB) group and the number average molecular weight of the PIB is from 200 to 600; a monohydric alcohol selected from methanol, ethanol, propanol or isopropanol; and ethylene glycol wherein the reaction product comprises compounds of formula (VII) and (VIII);
(iv) the reaction product of a polyhydric alcohol selected from ethylene glycol and propylene glycol and a compound of formula (I) or (II) in which one of R¹ and R³ is derived from an α-olefin having from 12 to 18 carbon atoms and the other one of R¹ and R³ is hydrogen; and
(v) the reaction product of a polyhydric alcohol selected from ethylene glycol and propylene glycol and a compound of formula (I) or (II) in which one of R¹ and R³ is a polyisobutene (PIB) group and the number average molecular weight of the PIB is from 200 to 600 and the other one of R¹ and R³ is hydrogen.

Preferably the or each ester lubricity additive is selected from one or more of:
(i) monoesters and/or diesters of glycerol and one or more unsaturated fatty acids selected from oleic acid and tall oil fatty acid; and
(ii) the reaction product of a polyhydric alcohol selected from ethylene glycol, diethylene glycol, propylene glycol, dipropylene glycol, glycerol and diglycerol and compound of formula (I) or (II) in which one of R¹ and R³ is derived from an internal olefin having from 14 to 18 carbon atoms and the other one of R¹ and R³ is hydrogen, wherein the compound of formula (I) or (II) and the polyhydric alcohol are reacted in a molar ratio of from 1:1 to 1:10 based on the ratio of COOH groups (or reactive equivalent thereof) in the compound of formula (I) or (II) to OH groups present in the polyhydric alcohol.

Mixtures of two or more of the ester lubricity additives (i) to (v) above may be included in the additive composition. Any suitable acid containing lubricity additive may be used as an acid lubricity additive. Suitable compounds will be known to the person skilled in the art.

Any compound which includes a carboxylic acid functional group and improves the lubricity of a drilling fluid to which it is added may be regarded as an acid lubricity additive.

Suitably, the or each acid lubricity additive comprises a monocarboxylic acid, for example a fatty acid.

Suitable fatty acids for use as the acid lubricity additive include compounds of formula R^{x}COOH as described above in relation to the preparation of the ester lubricity additive in which R^{x} is an alkyl or alkenyl group having from 5 to 35, preferably from 7 to 29 or from 11 to 23, carbon atoms. Preferably the fatty acid is unsaturated and R^{x} is an alkenyl group. The alkenyl group may have one or more double bonds, for example 1, 2 or 3 double bonds. Preferably the fatty acid is an unsaturated fatty acid having from 12 to 24, preferably from 16 to 18, carbon atoms.

Suitable fatty acids include caprylic acid, capric acid, lauric acid, myristic acid, palmitic acid, stearic acid, arachidic acid, behenic acid, lignoceric acid, cerotic acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, undecylenic acid and docosahexenoic acid. One preferred fatty acid is oleic acid.

Examples of suitable saturated carboxylic acids include capric acid, lauric acid, myristic acid, palmitic acid, and behenic acid.

Examples of suitable unsaturated carboxylic acids include oleic acid, elaidic acid, palmitoleic acid, petroselic acid, ricinoleic acid, eleostearic acid, linoleic acid, linolenic acid, eicosanoic acid, galoleic acid, erucic acid and hypogeic acid. Oleic acid is preferred.

Mixtures of fatty acids may also be used, such as for example, tall oil fatty acid. Tall oil fatty acid comprises a mixture of predominantly unsaturated fatty acids having mostly 18 carbon atoms. Typically tall oil fatty acids comprise mainly oleic acid and linoleic acids. Further examples of mixtures of fatty acids include soy bean, canola, coconut, palm and rapeseed oil (all of which are derived from natural sources).

The skilled person will appreciate that fatty acids derived from natural sources typically comprise mixtures of compounds.

Any suitable amide containing lubricity additive may be used as an amide lubricity additive. Suitable compounds will be known to the person skilled in the art.

Any compound which includes an amide functional group and improves the lubricity of a drilling fluid to which it is added may be regarded as an amide lubricity additive. Non-limiting examples of suitable amide lubricity additives are disclosed in US20040154217, US20040154218, WO 01/72930, U.S. Pat. Nos. 5,858,029, 4,867,752, 7,846,224, 8,690,968, 8,388,704, 7,846,224 and US20130288937.

The amide lubricity additive may comprise the reaction product of reactants comprising an amine and a fatty acid or a reactive derivative thereof. Thus, the amide lubricity additive may comprise an alkanolamide and/or a dialkanolamide.

Suitable fatty acids for use in the preparation of the amide lubricity additive include compounds of formula R^{x}COOH as described above in relation to the preparation of the ester lubricity additive in which R^{x} is an alkyl or alkenyl group having from 5 to 23, preferably from 5 to 17, carbon atoms.

Suitable fatty acids for the preparation of the amide lubricity additive include fatty acids derived from coconut oils.

The skilled person would understand that any suitable reactive derivative of a fatty acid may be used to prepare the amide lubricity additive. Examples of suitable reactive derivatives include an acyl chloride or anhydride derivative.

Any suitable amine may be reacted with the fatty acid or a reactive derivative thereof to prepare an amide lubricity additive. Suitable amines include diethanolamine, ethanol amine, propanolamine, dipropanolamine, isopropanolamine, di(isopropanol) amine and 2-(2-aminoethylamino) ethanol.

Preferred amide lubricity additives include fatty acid alkanolamides, especially cocodiethanolamide and oleic acid diethanolamide.

Preferably, the or each lubricity additive is selected from one or more of:
(a) an acid lubricity additive of the formula R^{x}COOH where R^{x} is an alkyl or alkenyl group having from 11 to 23 carbon atoms;
(b) an ester lubricity additive selected from one or more of:
   (i) monoesters and/or diesters of glycerol and one or more unsaturated fatty acids selected from oleic acid and tall oil fatty acid; and
   (ii) the reaction product of a polyhydric alcohol selected from ethylene glycol, diethylene glycol, propylene glycol, dipropylene glycol, glycerol and diglycerol and compound of formula (I) or (II) in which one of R¹ and R³ is derived from an internal olefin having from 14 to 18 carbon atoms and the other one of R¹ and R³ is hydrogen, wherein the compound of formula (I) or (II) and the polyhydric alcohol are reacted in a molar ratio of from 1:1 to 1:10 based on the ratio of COOH groups (or reactive equivalent thereof) in the compound of formula (I) or (II) to OH groups present in the polyhydric alcohol; and
(c) an amide lubricity additive that is a fatty acid alkanolamide.

Mixtures of two or more of the ester lubricity additives (a) to (c) above may be included in the additive composition.

The additive composition according to the first aspect comprises at least one emulsifier compound. The term an “emulsifier compound” has its usual meaning as would be understood by a person skilled in the art, i.e. a compound capable of dispersing a hydrocarbon component within an aqueous component or an aqueous component within a hydrocarbon component, wherein each component is not soluble in or miscible with the other component, to form an emulsified mixture of the two components.

The additive composition comprises at least one emulsifier compound. The additive composition may therefore comprise one emulsifier compound or two or more emulsifier compounds. References herein to “an” emulsifier compound or “the” emulsifier compound, unless otherwise specified, also apply to embodiments in which two or more such compounds are present.

The additive composition may comprise the or each emulsifier compound in any suitable amount, such as an amount of from 3 to 60 wt %, for example from 20 to 55 wt %, such as from 30 to 50 or from 25 to 48 wt %.

Suitably the at least one lubricity additive and the at least one emulsifier compound are present in the additive composition at a weight ratio of from 2:1 to 1:10, for example from 1:1 to 1:2, for example from 1:1 to 1:1.5.

The additive composition may comprise any suitable emulsifier compound(s). For example, the or each emulsifier compound may be selected from a non-ionic emulsifier compound, a cationic emulsifier compound, an amphoteric emulsifier compound and an anionic emulsifier compound, including mixtures thereof.

Suitably, the or each emulsifier compound may be selected from a non-ionic emulsifier compound and an amphoteric emulsifier compound, including mixtures thereof.

Suitably, the or each emulsifier compound may be selected from a non-ionic emulsifier compound, an anionic emulsifier compound and an amphoteric emulsifier compound, including mixtures thereof.

Suitably, the additive composition may comprise at least one non-ionic emulsifier compound.

Suitable non-ionic emulsifier compounds include alkoxylate compounds. Examples of suitable alkoxylate compounds include a fatty alcohol alkoxylate (such as a C8-24 fatty alcohol alkoxylate), a fatty acid amide alkoxylate, a hydroxy fatty acid alkoxylate, a triglyceride alkoxylate, a tristyryl phenol alkoxylate, a fatty acid ester of alkoxylated (such as ethoxylated) sorbitan, a polyalkylene alkoxylate, a glycerol alkoxylate, a fatty acid alkoxylate (such as ethoxylate), an alkoxylated alkyl phenol, a polyalkylene glycol ether (such as a polyethylene glycol ether) and a polyalkoxylated (such as polyethoxylated) tallow amine.

Suitable non-ionic emulsifier compounds also include a fatty alcohol (such as a C8-24 fatty alcohol), a fatty acid alkanolamide (such as a C8-24 fatty acid alkanolamide), a fatty acid ester, a sugar ester and an alkyl polyglucoside (such as a C10-16 alkyl polyglucoside).

Thus, suitable non-ionic emulsifier compounds may be selected from at least one of an alkoxylate compound, a fatty alcohol (such as a C8-24 fatty alcohol), a fatty acid alkanolamide (such as a C8-24 fatty acid alkanolamide), a fatty acid ester of sorbitan, a fatty acid ester, a sugar ester and an alkyl polyglucoside (such as a C10-16 alkyl polyglucoside). For example, suitable non-ionic emulsifier compounds may be selected from at least one of an alkoxylate compound, a fatty alcohol (such as a C8-24 fatty alcohol), a fatty acid ester of sorbitan, a fatty acid ester, a sugar ester and an alkyl polyglucoside (such as a C10-16 alkyl polyglucoside).

Examples of suitable non-ionic emulsifier compounds include at least one of a fatty alcohol (such as a C8-24 fatty alcohol), a fatty alcohol alkoxylate (such as a C8-24 fatty alcohol alkoxylate), a fatty acid alkanolamide (such as a C8-24 fatty acid alkanolamide), a fatty acid amide alkoxylate, a hydroxy fatty acid alkoxylate, a triglyceride alkoxylate, a tristyryl phenol alkoxylate, a fatty acid ester of alkoxylated (for example ethoxylated) sorbitan, a fatty acid ester of sorbitan, a polyalkylene alkoxylate, a glycerol alkoxylate, a fatty acid alkoxylate (such as ethoxylate), a fatty acid ester, a sugar ester, an alkyl polyglucoside (such as a C10-16 alkyl polyglucoside), an alkoxylated alkyl phenol, a polyalkylene glycol ether (such as a polyethylene glycol ether) and a polyalkoxylated (such as polyethoxylated) tallow amine.

Examples of suitable non-ionic emulsifier compounds may include at least one of a fatty alcohol (such as a C8-24 fatty alcohol), a fatty alcohol alkoxylate (such as a C8-24 fatty alcohol alkoxylate), a fatty acid amide alkoxylate, a hydroxy fatty acid alkoxylate, a triglyceride alkoxylate, a tristyryl phenol alkoxylate, a fatty acid ester of alkoxylated (for example ethoxylated) sorbitan, a fatty acid ester of sorbitan, a polyalkylene alkoxylate, a glycerol alkoxylate, a fatty acid alkoxylate (such as ethoxylate), a fatty acid ester, a sugar ester, an alkyl polyglucoside (such as a C10-16 alkyl polyglucoside), an alkoxylated alkyl phenol, a polyalkylene glycol ether (such as a polyethylene glycol ether) and a polyalkoxylated (such as polyethoxylated) tallow amine.

Suitable fatty alcohol compounds include C8-24 fatty alcohols, which may comprise a mixture of C8-24 fatty alcohols. For example, a suitable fatty alcohol compound is a C16-18 fatty alcohol such as cetearyl alcohol.

Suitable fatty alcohol alkoxylate compounds include, for example, C8-24, such as C9-15, for example C14-15, fatty alcohol alkoxylates. In other words, the fatty alcohol alkoxylate compounds may be derived from fatty alcohols comprising from 8 to 24, such as from 9 to 15, for example 14 or 15, carbon atoms, typically a mixture of such fatty alcohols. The fatty alcohol alkoxylate compounds may be derived from any suitable fatty alcohol, for example from stearyl alcohol, cocoyl alcohol, or from alcohol derived from soy or tallow. The fatty alcohols may be alkoxylated with ethylene oxide and/or propylene oxide, i.e. to provide ethoxylated and/or propylated compounds. Typically, the fatty alcohols are ethoxylated. For example, the fatty alcohol alkoxylate compounds may be derived from fatty alcohols comprising 8-18 carbon atoms and may be alkoxylated with 5 to 20 moles of alkylene oxide (for example ethylene oxide). Examples of suitable fatty alcohol alkoxylate compounds include ethoxylated (5-8 mols of EO) C8-13 fatty alcohol, ethoxylated (12 mols of EO) C12-15 fatty alcohol, ethoxylated (5-7 mols of EO) 9-11 fatty alcohol, C14-15 pareth-13, ceteareth-20 (C14-16); oleth-5 and PPG-5-ceteth-20. These compounds are commercially available, for example under the Tomadol® tradename.

Suitable fatty acid alkanolamide compounds include, for example, C8-C24 fatty acid alkanolamides, such as cocodiethanolamide, cocomonoethanolamide, rapeseed oil diethanolamide and oleic acid diethanolamide. When present fatty acid alkanolamides primarily act as lubricity additives but may also act as an emulsifier.

Suitable hydroxy fatty acid amide alkoxylate compounds include, for example, ethoxylated (EO50) hydrogenated palmalkylamide and ethoxylated (EO13) hydrogenated tallow alkylamide.

Suitable hydroxy fatty acid alkoxylate compounds include, for example, castor oil alkoxylates (such as ethoxylates and/or propoxylates).

Suitable triglyceride alkoxylate compounds include triglyceride ethoxylates (EO12-54) and hydrogenated PEG-50 castor oil.

A suitable tristyryl phenol alkoxylate is, for example, an EO14-54 tristyryl phenol alkoxylate or an EO60 tristyryl phenol alkoxylate. These compounds are commercially available such as for example Makon 60.

Suitable fatty acid esters of alkoxylated sorbitan include fatty acid esters of ethoxylated sorbitan, for example a fatty acid ester of ethoxylated (EO20) sorbitan. These compounds are also known as Tweens. Preferred such compounds include, for example, a mono ester of ethoxylated sorbitan with one or more of lauric acid, palmitic acid, oleic acid and stearic acid.

Suitable fatty acid esters of sorbitan include, for example, monostearate esters, tristearate esters and monolaurate esters. These compounds are also known as Spans.

Suitable polyalkylene alkoxylate compounds include polyethylene oxide, polypropyene oxide, block copolymers of poly(ethylene oxide) and poly(propylene oxide), or a glycerol alkoxylate.

Suitable fatty acid alkoxylate compounds include, for example, a fatty acid ethoxylate compounds. The fatty acid alkoxylate (or ethoxylate) compounds may be prepared from any suitable fatty acids. Suitable fatty acids may comprise from 8 to 22 carbon atoms and may be synthetic or natural. Examples of suitable natural fatty acids include those derived from soy, palm, canola, rapeseed and coconut.

Suitable fatty acid ester compounds include, for example, polyglycerol-2 sesquiisostearate, polyglycerol-2 distearate, polyglycerol-2 polyricinoleate, PEG-4 polyglycerol-2 stearate, glyceryl stearate and sodium stearoyl lacylate.

Suitable sugar ester compounds include, for example sorbitan olivate, sucrose polystearate and sunflower seed oil sorbitol esters.

Suitable alkyl polyglucoside compounds include, for example, C10-16 alkyl polyglucoside compounds, such as lauryl glucoside.

Suitable alkoxylated alkylphenol compounds include ethoxylated alkylphenol compounds, such as for example EO6-50 nonylphenol.

Suitable polyalkoxylated tallow amine compounds include polyethoxylated tallow amine compounds, such as N-tallow-poly (3) oxyethylene-1,3-diaminopropane.

Preferred combinations of non-ionic emulsifier compounds may comprise a fatty alcohol alkoxylate (such as a C8-24 fatty alcohol alkoxylate), a tristyryl phenol alkoxylate and a polyalkoxylated (such as polyethoxylated) tallow amine.

For example, the or each non-ionic emulsifier compounds preferably include C14-15 Pareth-13 and/or N-tallow-poly (3) oxyethylene-1,3-diaminopropane.

Suitably, the additive composition may comprise at least one amphoteric emulsifier compound.

Any suitable amphoteric emulsifier compounds may be included in the additive composition. Suitable amphoteric emulsifier compounds would be known to persons skilled in the art. Examples of suitable amphoteric emulsifier compounds include at least one of a betaine, a sultaine, an amine oxide and a phosphatidylcholine.

Suitable betaine compounds include, for example, a C8-18 alkylamido propyl betaine, suitably lauryl amidopropyl betaine and/or cocamidopropyl betaine.

Suitable sultaine compounds include, for example, a C8-18 alkylamido hydroxyalkyl sultaine, suitably cocamidopropyl hydroxysultaine.

Suitable amine oxide compounds include, for example, lauryldimethylamine oxide.

Suitable phosphatidylcholine compounds include, for example, dipalmitoylphosphatidylcholine.

The amphoteric emulsifier compound may comprise a source of a phosphatidylcholine compound, such as lecithin. Lecithin may be obtained by extraction from a suitable source such as egg yolk, sunflower oil, soybean, milk, rapeseed, cotton seed and peanuts. For example, lecithin derived from soybean may be known as soy lecithin.

Suitably, the additive composition may comprise at least one anionic emulsifier compounds.

Any suitable anionic emulsifier compounds may be included in the additive composition. Suitable anionic emulsifier compounds would be known to persons skilled in the art.

Suitable anionic emulsifier compounds may comprise at least one of a sulfonate, a sulfate or a phosphate group, or a salt or a derivative thereof.

Suitable anionic emulsifier compounds include, for example, an alkylbenzene sulfonate compound, an α-olefin sulfonate, an ether sulfate, a sulphosuccinate, a phosphate, or a salt or a derivative of any of the aforementioned, or an N-acyl amino acid.

Suitable alkylbenzene sulfonate compounds when present as emulsifier compounds may comprise linear or branched alkyl groups having from 8 to 14 carbon atoms. For example, a suitable alkylbenzene sulfonate compound may be dodecylbenzenesulfonate (DDBS), or a salt or a derivative thereof. Examples of suitable salts include alkanolamine, isopropylamine and calcium salts.

Suitable α-olefin sulfonate compounds include C12-22, for example C14-16, α-olefin sulfonate compounds, and salts and derivatives thereof.

Suitable ether sulfate compounds include, for example, sodium lauryl sulfate (SLS) and sodium lauryl ether sulfate (SLES), and salts and derivatives thereof.

Suitable sulphosuccinate compounds include, for example, for example a dialkyl sulfosuccinate, such as a dioctyl sulfosuccinate, and salts and derivatives thereof.

Suitable phosphate compounds include, for example, fatty alcohol ethoxylated phosphate compounds and phosphate esters of an ethoxylated alkylphenol. Suitable fatty alcohol ethoxylated phosphate compounds include a phosphate of a EO3-30 C10-15 alcohol, preferably trilaureth-4 phosphate or triceteareth-4 phosphate. Suitable phosphate esters of an ethoxylated alkylphenol include, for example phenol EO3 phosphate, nonylphenol EO6-10 phosphate and salts thereof, suitably sodium salts thereof.

Suitable N-acyl amino acids include the reaction product of a fatty acid or reactive equivalent thereof and an amino acid such as, for example, alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine and valine.

Suitably, the additive composition may comprise at least one cationic emulsifier compound.

Any suitable cationic emulsifier compounds may be included in the additive composition. Suitable cationic emulsifier compounds would be known to persons skilled in the art.

Examples of suitable cationic emulsifier compounds include at least one quaternary ammonium compound commonly referred to as an ammonium compound (including di-quaternary ammonium compounds).

Suitable ammonium compounds may be prepared from a fatty alkyl amine, for example wherein the alkyl group may contain from 8 to 36, for example from 8 to 24, carbon atoms.

Suitable ammonium compounds include, for example, alkyl trimethyl ammonium compounds, dialkyl dimethyl ammonium compounds, trialkyl methyl ammonium compounds, benzyl alkyl dimethyl ammonium compounds and benzyl dialkyl methyl ammonium compounds. Suitable counteranions for the ammonium compounds include, for example, halide (preferably chloride), salicylate and sulfate.

Suitable alkyl trimethyl ammonium compounds include those wherein the alkyl group is selected from dodecyl, hexadecyl, octadecyl, cocoyl, soy alkyl, tallow alkyl, 2-ethylhexyl and hydrogenated tallow, and mixtures thereof. Suitable alkyl trimethyl ammonium compounds include, for example, dodecyl trimethyl ammonium compound, hexadecyl trimethyl ammonium compound, octadecyl trimethyl ammonium compound, cocoyl trimethyl ammonium compound, soy alkyl trimethyl ammonium compound, tallow alkyl trimethyl ammonium compound, 2-ethylhexyl trimethyl ammonium compound, and hydrogenated tallow trimethyl ammonium compound.

Suitable dialkyl dimethyl ammonium compounds include those wherein the alkyl group is selected from cocoyl, hydrogenated tallow and 2-ethyl hexyl, and mixtures thereof. For example, the alkyl groups may be a mixture of two different alkyl groups, such as 2-ethyl hexyl and hydrogenated tallow.

Suitable trialkyl methyl ammonium compounds include those wherein the alkyl group is hexadecyl. For example a suitable trialkyl methyl ammonium compound is a tri (hexadecyl) methyl ammonium compound such as tri (hexadecyl) methyl ammonium chloride.

Suitable benzyl alkyl dimethyl ammonium compounds include those wherein the alkyl group is selected from cocoyl and hydrogenated tallow, and mixtures thereof. Preferred benzyl alkyl dimethyl ammonium compounds are benzyl alkyl dimethyl ammonium chloride compounds.

Suitable benzyl dialkyl methyl ammonium compounds include those wherein the alkyl group is hydrogenated tallow and/or wherein the counteranion is chloride.

Suitable ammonium compounds include di-quaternary ammonium compounds, for example N,N,N′,N′, N′-pentamethyl-N-tallow-1,3-propanediammoniumdichloride (available commercially as Duoquad T-50 E).

Suitable ammonium compounds include quaternised ethoxylated fatty amine compounds. Suitable quaternised ethoxylated fatty amine compounds include those derived from a fatty amine comprising an alkyl group selected from octadecyl, oleyl, cocoyl and tallow, and mixtures thereof. The fatty amine compounds may be alkoxylated with ethylene oxide and/or propylene oxide, i.e. to provide ethoxylated and/or propylated compounds. Typically, the fatty amines are ethoxylated, for example with 2 to 15 moles of ethylene oxide. Suitable quaternising agents include methyl chloride, methyl nitrate and methyl acetate.

Preferably the additive composition may comprise at least one non-ionic emulsifier compound and at least one amphoteric emulsifier compound, wherein the non-ionic emulsifier compound is selected from one or more of a fatty alcohol alkoxylate (such as a C8-24 fatty alcohol alkoxylate) and a tristyryl phenol alkoxylate, and wherein the amphoteric emulsifier compound may comprise at least one phosphatidylcholine compound.

More preferably the additive composition may comprise at least one non-ionic emulsifier compound and lecithin (such as soy lecithin), wherein the non-ionic emulsifier compound is selected from one or more of a fatty alcohol alkoxylate (such as a C8-24 fatty alcohol alkoxylate) and a tristyryl phenol alkoxylate. For example, the additive composition may comprise a fatty alcohol alkoxylate (such as a C8-24 fatty alcohol alkoxylate) and lecithin (such as soy lecithin).

For example, the additive composition may comprise a tristyryl phenol alkoxylate and lecithin (such as soy lecithin).

Preferably the additive composition may comprise at least one non-ionic emulsifier compound, at least one amphoteric emulsifier compound and at least one anionic emulsifier compound, wherein the non-ionic emulsifier compound is selected from one or more of a fatty alcohol alkoxylate (such as a C8-24 fatty alcohol alkoxylate) and a tristyryl phenol alkoxylate, the amphoteric emulsifier compound may comprise at least one phosphatidylcholine compound and the anionic emulsifier compound may comprise an alkylbenzene sulfonate compound.

More preferably the additive composition may comprise at least one non-ionic emulsifier compound, lecithin (such as soy lecithin). and at least one anionic emulsifier compound, wherein the non-ionic emulsifier compound is selected from one or more of a fatty alcohol alkoxylate (such as a C8-24 fatty alcohol alkoxylate) and a tristyryl phenol alkoxylate and wherein the anionic emulsifier compound may comprise an alkylbenzene sulfonate compound. For example, the additive composition may comprise a fatty alcohol alkoxylate (such as a C8-24 fatty alcohol alkoxylate), lecithin (such as soy lecithin) and an alkylbenzene sulfonate compound. For example, the additive composition may comprise a tristyryl phenol alkoxylate, lecithin (such as soy lecithin) and an alkylbenzene sulfonate compound.

Preferably the additive composition may comprise at least one non-ionic emulsifier compound and at least one amphoteric emulsifier compound, wherein the non-ionic emulsifier compound is selected from one or more of a fatty alcohol alkoxylate (such as a C8-24 fatty alcohol alkoxylate) and a polyalkoxylated tallow amine compound and the amphoteric emulsifier compound comprises at least one phosphatidylcholine compound.

More preferably the additive composition may comprise at least one non-ionic emulsifier compound and lecithin (such as soy lecithin), wherein the non-ionic emulsifier compound is selected from one or more of a fatty alcohol alkoxylate (such as a C8-24 fatty alcohol alkoxylate) and a polyalkoxylated tallow amine compound. For example, the additive composition may comprise a fatty alcohol alkoxylate (such as a C8-24 fatty alcohol alkoxylate), a polyalkoxylated tallow amine compound and lecithin (such as soy lecithin). For example, the additive composition may comprise a C8-24 fatty alcohol alkoxylate), a polyethoxylated tallow amine compound and lecithin (such as soy lecithin).

The additive composition may further comprise any suitable additional components. Examples of suitable such additional components include solvents, preservatives, anti-oxidants, antifoam agents, performance additives and stabilisers as would be known to persons skilled in the art.

Antifoam agents may be present in the additive composition in an amount of from 0 to 5 wt %.

Examples of suitable solvents include water, alcohols (such as isopropanol), aromatic hydrocarbons, glycols, aliphatic hydrocarbons and diesel, and mixtures thereof.

Solvents may be present in the additive composition in an amount of from 0 to 25 wt %.

Examples of suitable performance additives include alkylbenzene sulfonates having an average MW of 400-425.

The additive composition of the first aspect may, for example, comprise from 10 to 75 wt % of the at least one lubricity additive, from 20 to 55 wt % of the at least one emulsifier compound, from 0 to 5 wt % of an antifoam agent and from 0 to 25 wt % of a solvent.

The additive composition according to the first aspect is suitably prepared by admixing the at least one lubricity additive with the at least one emulsifier compound and optionally with any additional components present. The additive composition may be prepared in advance of use and stored in its admixed form. Alternatively the additive composition may be prepared immediately before use.

The additive composition is preferably a liquid at room temperature and pressure.

The additive composition is suitably biodegradable and environmentally friendly.

The additive composition is suitable for use with and may be mixed with a drilling fluid, suitably an aqueous drilling fluid.

Suitably the additive composition of the first aspect provides improvements to lubricity in drilling fluids, suitably aqueous drilling fluids.

According to a second aspect of the invention, there is provided a drilling fluid composition comprising an aqueous drilling fluid and the additive composition according to the first aspect.

Features of the additive composition in relation to the second aspect of the invention are as disclosed herein in relation to the first aspect of the invention.

Any suitable aqueous drilling fluid may be included in the drilling fluid composition.

The aqueous drilling fluid may comprise one or more inorganic ions. For example the aqueous drilling fluid may comprise one or more ions selected from magnesium ions, calcium ions, sodium ions, potassium ions, chloride ions, and sulfate ions. Preferably the aqueous drilling fluid comprises calcium ions.

The aqueous drilling fluid may comprise inorganic ions in an amount of from 0 to 350,000, for example from 2,000 to 100,000, preferably from 3,000 to 50,000 ppm, based on the total dissolved solids (TDS).

The aqueous drilling fluid may comprise calcium ions in an amount of from 0 to 40,000, preferably from 5,000 to 25,000, ppm. Suitably the aqueous drilling fluid may comprise calcium ions at the saturation concentration thereof.

The drilling fluid composition is suitably formed by admixing the aqueous drilling fluid with the additive composition according to the first aspect. When present, the one or more inorganic ions may be added to the drilling fluid composition after its formulation or may be present in the aqueous drilling fluid prior to admixing.

Preferably the aqueous drilling fluid comprises at least one of brine, freshwater, produced water, formation water, and seawater, preferably freshwater, produced water or a mixture thereof. The aqueous drilling fluids may comprise mixtures of two or more of brine, freshwater, produced water, formation water, and seawater. Suitably the aqueous drilling fluid comprises freshwater.

The drilling fluid composition of the second aspect may further comprise one or more friction reducer compounds. Suitable friction reducer compounds will be known to the skilled person.

Suitable friction reducer compounds for use herein include polyacrylamides, for example polyacrylamides comprising repeat units derived from optionally substituted acrylamides and/or optionally substituted acrylic acids.

Preferably the or each friction reducer compound is a polyacrylamide comprising repeat units derived from one or more monomers including an acrylamide and one or more of an acrylic acid and 2-acrylamido-2-methylpropane sulfonic acid (AMPS).

Preferably the or each friction reducer compound is a polyacrylamide comprising repeat units derived from monomers including acrylamide and acrylic acid.

Preferably the or each friction reducer compound is a polyacrylamide comprising repeat units derived from monomers including acrylamide and 2-acrylamido-2-methylpropane sulfonic acid (AMPS).

Preferably the or each friction reducer compound is a polyacrylamide comprising repeat units wherein about 70 mol % of the repeat units are derived from acrylamide monomers and about 30 mol % of the repeat units are derived from acrylic acid monomers and/or AMPS monomers.

The or each friction reducer compound may be a polyacrylamide having a molecular weight of at least 200,000 Daltons. Said molecular weight may be at least 500,000 Daltons, preferably at least 1,000,000 Daltons. The molecular weight may be less than 50,000,000 Daltons or less than 30,000,000 Daltons. Molecular weight, described herein, may be measured by Measurement of Intrinsic Viscosity (see ISO 1628/1-1984-11-01); and using Intrinsic

Viscosity/Molecular Weight Correlation via the Mark-Houwink Equation). Said molecular weight may be in the range 15,000,000-20,000,000 Daltons.

The addition to the drilling fluid composition of the second aspect of one or more friction reducer compounds as defined herein facilitates the injection and pumping of the drilling fluid composition at higher rates and pressures, at a lower energy use, as required for various on shore and offshore oilfield applications. Suitable oilfield applications include standard drilling processes, hydraulic fracturing processes and coil tube drilling processes. Preferred oilfield applications include standard drilling processes and coil tube drilling processes.

Suitably the drilling fluid composition is a coil tube drilling fluid composition.

The drilling fluid composition of the second aspect is suitably an aqueous composition.

The drilling fluid composition may comprise the aqueous drilling fluid in an amount of up to 99 vol %, preferably from 94 to 97 vol %.

The drilling fluid composition may comprise the additive composition in an amount of from 1 to 15 vol %, such as from 2 to 10 vol %, preferably from 3 to 6 vol %.

The drilling fluid composition according to the second aspect may comprise any suitable additional components. Examples of suitable additional components include any one or more of: hardness control/water softening agents; pH control agents; fluid loss agents, especially carboxymethyl starch or carboxymethyl cellulose; viscosifiers; salts and other weighting agents; scale inhibitors; lost circulation material or bridging agents; defoaming/foam control agents; anti-accretion additives; biocides; corrosion inhibitors; oxygen scavengers; hydrogen sulfide scavengers; scale inhibitors; pipe-release agents; dispersants; dewatering agents; and filter cake removal agents.

A person skilled in the art would be able to select suitable additional components and treat rates thereof for a drilling fluid composition of the second aspect according to the intended application thereof.

Examples of suitable viscosifiers include clays for example attapulgite; and polysaccharides and derivatives thereof for example cellulose, carboxymethyl cellulose, hydroxyethyl cellulose, polyanionic cellulose, guar, diutan, starch, chitin, chitosan, glycogen, xanthan, dextran, dextrin, welan, gellan, pullulan, pectin, scleroglucan, schizophyllan, levan, locust bean gum, peptidoglycan, tara, konjak, tamarind, starch, karaya, tragacanth, carrageenan, glycan, succinoglycan, glucan, scleroglucan, maltodextrin and cyclodextrin. Preferred are xanthan and/or diutan.

Examples of suitable salts and other weighting agents include KCl, NaCl, MgCl₂, barite (barium sulfate), calcium carbonate, iron oxide and galena.

Examples of suitable lost circulation materials/bridging agents include crushed nut shells, shredded cellophane, carbonate particles, diatomaceous earth, marble, starch, lignins and tanins, ground tire, paper, polyethylene chips and polylactic acid. These may be in the form of fine powder, coarse powder, fibres or flakes.

Examples of suitable fluid loss agents include polyanionic cellulose, sodium polyacrylates, carboxymethyl starch and carboxymethyl cellulose.

Examples of suitable defoaming/foam control agents include aluminium stearate, alkyl phosphate, polyols and silicones.

Examples of suitable ant-accretion additives include fatty acid soaps.

Examples of suitable biocides include glutaraldehyde, quaternary ammonium chloride salts including alkyldimethylbenzylammonium chlorides and alkyltrimethylammonium chlorides, peracetic acid, methylisothiazolinone, bronopol and tetrakis (hydroxymethyl) phosphonium sulfate (THPS).

Examples of suitable corrosion inhibitors include imidazolines, alkoxylated alcohols and triazoles.

Examples of suitable oxygen scavengers include aluminium bisulfate.

Examples of suitable hydrogen sulfide scavengers include iron oxide, zinc carbonates, zinc oxide, triazine and acrolein.

Examples of suitable scale inhibitors include phosphate esters and phosphonates.

Examples of suitable dewatering agents include polyamines, polyacrylamides and DADMAC copolymers.

Examples of suitable filter cake removal agents include α-amylase enzymes.

Examples of suitable hardness control agent includes soda ash (carbonate).

The drilling fluid composition as defined herein may be used in any suitable drilling operation as would be understood by a person skilled in the art. For example, the drilling fluid composition may be used in the drilling of a bore hole such as a wellbore (for use in a standard drilling or hydraulic fracturing process) or it may be used to remove blockages, such as cement plugs or frac plugs (including composite frac plugs), in a wellbore, for example after a fracturing process has been completed. Any suitable medium may be drilled through using the drilling fluid composition including but not limited to rock, shale, sandstone, cement, concrete, sand and composites (such as composites containing or made from plastic, metal or polymer or mixtures of these).

According to a third aspect of the invention, there is provided a method of preparing a drilling fluid composition, the method comprising admixing an aqueous drilling fluid, the additive composition according to the first aspect and optionally one or more friction reducer compounds.

Features of the additive composition in relation to the third aspect of the invention are as disclosed herein in relation to the first and second aspects of the invention.

The method according to the third aspect may provide a drilling fluid composition according to the second aspect. Preferably the aqueous drilling fluid comprises calcium ions.

The aqueous drilling fluid for use in the method according to the third aspect may comprise at least one of brine, freshwater, produced water, formation water, and seawater, preferably freshwater, produced water or a mixture thereof. The aqueous drilling fluids may comprise mixtures of two or more of brine, freshwater, produced water, formation water, and seawater. Suitably the aqueous drilling fluid comprises freshwater.

The method according to the third aspect may comprise the step of forming the aqueous drilling fluid by combining freshwater with a calcium ion source.

According to a fourth aspect of the invention, there is provided a use of an additive composition according to the first aspect to provide lubricity in an aqueous drilling fluid.

Features of the additive composition in relation to the fourth aspect of the invention are as disclosed herein in relation to the first aspect of the invention.

According to a fifth aspect of the invention, there is provided a method of providing lubricity in an aqueous drilling fluid, the method comprising admixing the additive composition according to the first aspect with the aqueous drilling fluid.

Features of the additive composition and aqueous drilling fluid in relation to the fifth aspect of the invention are as disclosed herein in relation to the first to fourth aspects of the invention.

The lubricity of an aqueous drilling fluid can be measured by methods known to persons skilled in the art. For example, an industry standard test method ASTM D6079-22 may be used. This method evaluates lubricity improving additives by measuring the wear between two metal components in a high frequently reciprocating rig (HFRR).

According to a sixth aspect of the invention, there is provided a method of emulsifying at least one lubricity additive in an aqueous drilling fluid, the method comprising providing the additive composition according to the first aspect comprising the lubricity additive, and admixing the additive composition with the aqueous drilling fluid.

Features of the lubricity additive, additive composition and aqueous drilling fluid in relation to the sixth aspect of the invention are as disclosed herein in relation to the first to fifth aspects of the invention.

According to a seventh aspect of the invention there is provided a use of an additive composition according to the first aspect, for example wherein the additive composition has an HLB value of from 10 to 18 or from 12 to 18, to emulsify the at least one lubricity additive in an aqueous drilling fluid.

Suitably the aqueous drilling fluid defined in relation to the fourth to seventh aspects further comprises one or more friction reducer compounds as discussed herein.

Features of the lubricity additive, additive composition and aqueous drilling fluid in relation to the seventh aspect of the invention are as disclosed herein in relation to the first to sixth aspects of the invention.

According to an eighth aspect of the invention there is provided a use of an aqueous drilling composition according to the second aspect in a drilling operation.

According to a ninth aspect of the invention there is provided a method of drilling, wherein the method comprises drilling through a medium using a suitable drilling assembly in the presence of an aqueous drilling fluid according to the second aspect.

Features of the aqueous drilling fluid in relation to the eighth and ninth aspects of the invention are as disclosed herein in relation to the second aspect of the invention.

The use and method of the eighth and ninth aspects of the invention may apply to any suitable drilling operation as would be understood by a person skilled in the art. For example, a suitable drilling operation may be drilling a bore hole such as a wellbore (for use in a standard drilling or hydraulic fracturing process). Another suitable drilling operation may be drilling to remove blockages, such as cement plugs, in a wellbore, for example after a fracturing process has been completed. Any suitable medium may be drilled through using the drilling fluid composition including but not limited to rock, shale, sandstone, cement, concrete, sand and composites (such as composites containing or made from plastic, metal or polymer or mixtures of these).

### EXAMPLES

The invention will now be further described with reference to the following non-limiting examples. HLB values quoted herein were calculated based on the overall composition.

### Example 1

Additive compositions 1 and 2 were prepared by mixing the components according to Table 1.

TABLE 1

| Component (wt %) | Composition 1 | Composition 2 | Composition 3 |
|---|---|---|---|
| Diesel | 15 | 15 | 15 |
| Ester lubricity | 35 | 35 | 35 |
| improver* | | | |
| Isopropanol | 5 | 5 | 5 |
| Soy lecithin | 30 | 30 | 30 |
| Alkylbenzene sodium | 5 | 5 | — |
| sulfonate** | | | |
| Ethoxylated fatty | 10 | — | — |
| alcohol 1*** | | | |
| Ethoxylated fatty | — | 10 | — |
| alcohol 2**** | | | |
| Alkoxylated non-ionic | | | 10 |
| emulsifier***** | | | |
| HLB value | 14.4 | 13.1 | 8 |

*Commercially available ester lubricity improver formed by the reaction of a C16-18 alkenyl succinic anhydride and two moles of ethylene glycol. Contains 75 wt % active ester and 25 wt % aromatic solvent.
**Average MW of 400-425.
***Ethoxylated (12 moles EO) C12-15 fatty alcohols - 100 wt % active.
****Ethoxylated (5-7 moles EO) C9-11 fatty alcohols - 95 wt % active, 5 wt % water.
*****Commercially available alkoxylated non-ionic emulsifier with a combination of ethylene oxide and propylene oxide groups - 100% active.

### Emulsion Testing:

Compositions 1, 2 and 3 were each tested for their emulsion performance as follows: 0.5 ml of the composition to be tested and 12.0 ml of a 50,000 ppm calcium chloride brine was added to a test tube. The test tube was shaken manually for 30 seconds and visually monitored for emulsion formation and oil separation. The results were as set out in Table 2.

TABLE 2

| Composition | Result | Observation |
|---|---|---|
| 1 | Pass | Good emulsion, no oil ring |
| 2 | Pass | Good emulsion, no oil ring |
| 3 | Fail | No emulsion |

A pass rating was awarded when an emulsion formed and remained for 2 or more hours. An intermediate rating was awarded when an emulsion formed and remained between 30 minutes and 2 hours. A fail rating was awarded when the emulsion did not form, or when an emulsion formed but remained for fewer than 10 minutes.

### Example 2

Additive compositions 4 to 12, having different overall HLB values, were prepared by mixing the components according to Table 3.

TABLE 3

| | Composition | | | | | | | | |
|---|---|---|---|---|---|---|---|---|---|
| Component (wt %) | 4 | 5 | 6 | 7 | 8 | 9 | 10 | 11 | 12 |
| Diesel | 15 | 15 | 15 | 15 | 15 | 15 | 15 | 15 | 15 |
| Ester Lubricity improver* | — | — | 35 | — | — | 35 | — | — | 35 |
| Oleic acid | — | 35 | — | — | 35 | — | — | 35 | — |
| Cocodiethanolamide | 35 | — | — | 35 | — | — | 35 | — | — |
| lubricity improver | | | | | | | | | |
| Isopropanol | 5 | 5 | 5 | 5 | 5 | 5 | 5 | 5 | 5 |
| Soy lecithin | 30 | 30 | 30 | 30 | 30 | 30 | 30 | 30 | 30 |
| Alkylbenzene sodium | 5 | 5 | 5 | 5 | 5 | 5 | 5 | 5 | 5 |
| sulfonate** | | | | | | | | | |
| Ethoxylated fatty | 6.4 | 6.4 | 6.4 | 8 | 8 | 8 | — | — | — |
| alcohol 1*** | | | | | | | | | |
| Alkoxylated non-ionic | 3.6 | 3.6 | 3.6 | — | — | — | — | — | — |
| emulsifier**** | | | | | | | | | |
| Ethoxylated | — | — | — | 2 | 2 | 2 | 10 | 10 | 10 |
| tristrylphenol**** | | | | | | | | | |
| HLB value | 12 | 12 | 12 | 15 | 15 | 15 | 18 | 18 | 18 |

*As in example 1.
**Average MW of 400-425.
***Ethoxylated (12 moles EO) C12-15 fatty alcohols - 100 wt % active.
****Commercially available alkoxylated non-ionic emulsifier with a combination of ethylene oxide and propylene oxide groups - 100% active.
*****tristrylphenol ethoxylated with an average of 60 moles EO.

### Emulsion Testing:

Compositions 4 and 6 to 12 were tested for their emulsion performance in different aqueous fluids using the same procedure as in Example 1. The results are summarised in Table 4.

TABLE 4

| Composition | Test fluid | Result |
|---|---|---|
| 4 | Brine: 15,000 ppm Ca & 9.5 ppg* | Pass |
| 4 | Brine: 15,000 ppm Ca & 10 ppg | Pass |
| 6 | Fresh water | Pass |
| 7 | Fresh water | Pass |
| 7 | Brine: 15,000 ppm Ca & 9.5 ppg | Pass |
| 7 | Brine: 15,000 ppm Ca & 10 ppg | Pass |
| 8 | Fresh water | Intermediate |
| 8 | Brine: 15,000 ppm Ca & 9.5 ppg | Intermediate |
| 8 | Brine: 15,000 ppm Ca & 10 ppg | Intermediate |
| 9 | Fresh water | Pass |
| 9 | Brine: 15,000 ppm Ca & 9.5 ppg | Pass |
| 9 | Brine: 15,000 ppm Ca & 10 ppg | Pass |
| 10 | Fresh water | Pass |
| 10 | Brine: 15,000 ppm Ca & 9.5 ppg | Pass |
| 11 | Brine: 15,000 ppm Ca & 9.5 ppg | Intermediate |
| 11 | Brine: 15,000 ppm Ca & 10 ppg | Intermediate |
| 12 | Brine: 15,000 ppm Ca & 9.5 ppg | Pass |
| 12 | Brine: 15,000 ppm Ca & 10 ppg | Pass |

*ppg = density of fluid in pounds per gallon (lb/gal).
Results were awarded using the same criteria as in Example 1.

### Example 3

Composition 13 was prepared by mixing the components according to Table 5.

TABLE 5

| Component (wt %) | Composition 13 |
|---|---|
| Diesel | 10.0 |
| Ester lubricity improver* | 39.0 |
| Soy Lecithin | 29.0 |
| Isopropanol | 5.0 |
| C14-15 Pareth-13 | 10.0 |
| N-tallow-poly (3) oxyethylene-1,3-diaminopropane | 5.0 |
| Polysiloxane defoamer | 2.0 |
| HLB Value | 13.7 |

*as in example 1

### Lubricity Performance:

The lubricity performance of Composition 13 was compared against a commercially available drilling fluid additive in a coefficient of friction test. The test used a 120V lubricity meter apparatus (which has a rotor and a block that creates friction when circulated using a torque wrench to apply the force on the block). The unit was initially calibrated with distilled water for 5 minutes, then a zero was applied and all parts and surfaces were cleaned and wiped prior to testing each additive.

The test was conducted with 250 ml of a drilling fluid composition containing 97 vol % of drilling fluid as described in Table 6 and 3 vol % of Composition 13 or 3 vol % of the commercially available drilling fluid additive.

The drilling fluid used for the test was a fully saturated brine.

The results are set out in Table 6.

TABLE 6

| | | | Coefficient of |
|---|---|---|---|
| Composition | Drilling Fluid | Torque (ft/lb) | friction (ft/lb) |
| Composition 13 | 7.5 pH, 6,000 ppm Ca | 150 | 2.6 |
| | and 10.0 ppg* | | |
| Commercial additive | 7.5 pH, 6,000 ppm Ca | 150 | 2.9 |
| | and 10.0 ppg | | |
| Composition 13 | 7.5 pH, 6,000 ppm Ca | 350 | 10.8 |
| | and 10.0 ppg | | |
| Commercial additive | 7.5 pH, 6,000 ppm Ca | 350 | 11.08 |
| | and 10.0 ppg | | |
| Composition 13 | 9.5 pH, 6,000 ppm Ca | 150 | 4.0 |
| | and 10.0 ppg | | |
| Commercial additive | 9.5 pH, 6,000 ppm Ca | 150 | 9.9 |
| | and 10.0 ppg | | |
| Composition 13 | 9.5 pH, 6,000 ppm Ca | 350 | 12.7 |
| | and 10.0 ppg | | |
| Commercial additive | 9.5 pH, 6,000 ppm Ca | 350 | 45.0 |
| | and 10.0 ppg | | |
| Composition 13 | 7.0 pH, 20,000 ppm | 150 | 2.6 |
| | Ca | | |
| Commercial additive | 7.0 pH, 20,000 ppm | 150 | 4.8 |
| | Ca | | |
| Composition 13 | 7.0 pH, 20,000 ppm | 350 | 9.15 |
| | Ca | | |
| Commercial additive | 7.0 pH, 20,000 ppm | 350 | 13.6 |
| | Ca | | |
| Composition 13 | 9.5 pH, 20,000 ppm | 150 | 5.5 |
| | Ca | | |
| Commercial additive | 9.5 pH, 20,000 ppm | 150 | 9.18 |
| | Ca | | |
| Composition 13 | 9.5 pH, 20,000 ppm | 350 | 23.34 |
| | Ca | | |
| Commercial additive | 9.5 pH, 20,000 ppm | 350 | 25.0 |
| | Ca | | |
| Composition 13 | 7 pH, 15,000 ppm | 150 | 1.99 |
| | Ca, 9.7 ppg | | |
| Commercial additive | 7 pH, 15,000 ppm | 150 | 7.25 |
| | Ca, 9.7 ppg | | |
| Composition 13 | 7 pH, 15,000 ppm | 350 | 6.63 |
| | Ca, 9.7 ppg | | |
| Commercial additive | 7 pH, 15,000 ppm | 350 | 14.43 |
| | Ca, 9.7 ppg | | |
| Composition 13 | 9.5 pH, 9.7 ppg | 150 | 2.79 |
| | weight | | |
| Commercial additive | 9.5 pH, 9.7 ppg | 150 | 3.78 |
| | weight | | |
| Composition 13 | 9.5 pH, 9.7 ppg | 350 | 9.72 |
| | weight | | |
| Commercial additive | 9.5 pH, 9.7 ppg | 350 | 28.29 |
| | weight | | |

*ppg = density of fluid in pounds per gallon (lb/gal).

Composition 13 provides a lower coefficient of friction in the test and thus improves the lubricity of the aqueous drilling fluid compared with the lubricity of the commercially available drilling fluid additive.

### Example 4

The lubricity benefit of composition 13 was assessed in a coil tube drilling application. The field test involved coil tube drilling through frac plugs installed between each stage of a 2 mile horizontal well bore after completion of a hydraulic fracturing operation, to remove the frac plugs.

The coil tube drilling fluid used was an aqueous fluid at 7.5 pH comprising around 6,000 ppm Ca and dosed with 1 to 3 wt % of composition 13 and 0.005 wt % of a polyacrylamide friction reducer.

The standard time limit allowed for drilling from the first frac plug to the last frac plug was 17 hours. The field test utilising the drilling fluid additised with composition 13 completed the drilling operation in 15 hours.

Although a few preferred embodiments have been shown and described, it will be appreciated by those skilled in the art that various changes and modifications might be made without departing from the scope of the invention, as defined in the appended claims.

Any feature of any aspect of any invention or embodiment described herein may be combined with any aspect of any other invention or embodiment described herein mutatis mutandis.

The Invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. An additive composition for an aqueous drilling fluid, the additive composition comprising at least one lubricity additive and at least one emulsifier compound.

2. The additive composition according to claim 1, wherein the additive composition has an HLB value of from 10 to 18, preferably from 12 to 18.

3. The additive composition according to claim 1, wherein the or each lubricity additive is selected from an ester lubricity additive, an acid lubricity additive and an amide lubricity additive, or a salt thereof.

4. The additive composition according to claim 3, wherein the or each ester lubricity additive comprises the reaction product of reactants comprising an alcohol and a carboxylic acid or a reactive equivalent thereof, wherein the carboxylic acid or reactive equivalent thereof is selected from a monocarboxylic acid and a polycarboxylic acid, or an anhydride thereof.

5. The additive composition according to claim 4, wherein the carboxylic acid or reactive equivalent thereof is a hydrocarbyl substituted succinic acid or a hydrocarbyl substituted succinic anhydride.

6. The additive composition according to claim 3, wherein the or each acid lubricity additive comprises a fatty acid.

7. The additive composition according to claim 3, wherein the or each amide lubricity additive comprises the reaction product of reactants comprising an amine and a fatty acid or a reactive equivalent thereof.

8. The additive composition according to claim 1, wherein the or each emulsifier compound is selected from a non-ionic emulsifier compound, a cationic emulsifier compound, an amphoteric emulsifier compound and an anionic emulsifier compound.

9. The additive composition according to claim 8, wherein the non-ionic emulsifier compound is selected from at least one of a fatty alcohol (such as a C8-24 fatty alcohol), a fatty alcohol alkoxylate (such as a C8-24 fatty alcohol alkoxylate), a fatty acid alkanolamide (such as a C8-24 fatty acid alkanolamide), a fatty acid amide alkoxylate, hydroxy fatty acid alkoxylate, a triglyceride alkoxylate, a tristyryl phenol alkoxylate, a fatty acid ester of alkoxylated (for example ethoxylated) sorbitan, a polyalkylene alkoxylate, a glycerol alkoxylate, a fatty acid alkoxylate (such as ethoxylate), a fatty acid ester of sorbitan, a fatty acid ester, a sugar ester, an alkyl polyglucoside (such as a C10-16 alkyl polyglucoside), an alkoxylated alkyl phenol, a polyalkylene glycol ether (such as a polyethylene glycol ether) and a polyalkoxylated (such as polyethoxylated) tallow amine.

10. The additive composition according to claim 8, wherein the amphoteric emulsifier compound is selected from at least one of a betaine, a sultaine, a nitrogen oxide and a phosphatidylcholine.

11. The additive composition according to claim 8, wherein the anionic emulsifier compound is selected from at least one of a sulfonate compound, a sulfate compound and a phosphate compound, or a salt or a derivative thereof.

12. The additive composition according to claim 8, wherein the cationic emulsifier compound is at least one ammonium compound.

13. The additive composition according to claim 1, comprising at least one non-ionic emulsifier compound and at least one amphoteric emulsifier compound, wherein the non-ionic emulsifier compound is selected from one or more of a fatty alcohol alkoxylate (such as a C8-24 fatty alcohol alkoxylate) and a tristyryl phenol alkoxylate, and wherein the amphoteric emulsifier compound comprises at least one phosphatidylcholine compound.

14. The additive composition according to claim 1, comprising at least one non-ionic emulsifier compound and at least one amphoteric emulsifier compound, wherein the non-ionic emulsifier compound is selected from one or more of a fatty alcohol alkoxylate (such as a C8-24 fatty alcohol alkoxylate) and a polyalkoxylated tallow amine compound and the amphoteric emulsifier compound comprises at least one phosphatidylcholine compound.

15. A drilling fluid composition comprising an aqueous drilling fluid and the additive composition according to claim 1.

16. The drilling fluid composition according to claim 15, wherein the aqueous drilling fluid comprises calcium ions.

17. The drilling fluid composition according to claim 15, wherein the aqueous drilling fluid comprises at least one of brine, freshwater, produced water, formation water, and seawater, preferably freshwater, produced water or a mixture thereof.

18. The drilling fluid composition according to claim 15, further comprising one or more friction reducer compounds.

19. A method of preparing a drilling fluid composition, the method comprising admixing an aqueous drilling fluid, the additive composition according to claim 1 and optionally one or more friction reducer compounds.

20. The method of preparing a drilling fluid composition according to claim 19, wherein the aqueous drilling fluid comprises calcium ions.

21. The method of preparing a drilling fluid composition according to claim 19, wherein the aqueous drilling fluid comprises at least one of brine, freshwater, produced water, formation water, and seawater, preferably freshwater, produced water or a mixture thereof.

22. The method of preparing a drilling fluid composition according to claim 19, wherein the method comprises the step of forming the aqueous drilling fluid by combining freshwater with a calcium ion source.

23. Use of an additive composition according to claim 1 to provide lubricity in an aqueous drilling fluid.

24. A method of providing lubricity in an aqueous drilling fluid, the method comprising admixing the additive composition according to claim 1 with the aqueous drilling fluid.

25. A method of emulsifying at least one lubricity additive in an aqueous drilling fluid, the method comprising providing the additive composition according to claim 2 comprising the lubricity additive, and admixing the additive composition with the aqueous drilling fluid.

26. Use of an additive composition according to claim 2, for example wherein the additive composition has an HLB value of from 10 to 18 or from 12 to 18, to emulsify the at least one lubricity additive in an aqueous drilling fluid.

27. A method or use according to claim 23, wherein the aqueous drilling fluid further comprises one or more friction reducer compounds.

28. Use of an aqueous drilling composition according to claim 15 in a drilling operation.

29. A method of drilling, wherein the method comprises drilling through a medium using a suitable drilling assembly in the presence of an aqueous drilling fluid according to claim 15.
